(19) United States
(12) Patent Application Publication
(10) Pub. No.: US 2013/0054301 A1
(43) Pub. Date: Feb. 28, 2013

(54) PROCESS REFINEMENT

(71) Applicants: Hamid Reza Motahari Nezhad, Los Altos, CA (US); Sven Graupner, Mountain View, CA (US); Claudio Bartolini, Palo Alto, CA (US)

(72) Inventors: Hamid Reza Motahari Nezhad, Los Altos, CA (US); Sven Graupner, Mountain View, CA (US); Claudio Bartolini, Palo Alto, CA (US)

(21) Appl. No.: 13/219,485

(22) Filed: Aug. 26, 2011

(51) Int. Cl. G06Q 10/06

(52) U.S. Cl. 705/7.27

(57) ABSTRACT

A customized process template is generated for an organization by customizing an abstract process template of a process for the organization. A discovered process model is generated based on enactment traces of the process. A suggestion for refining the process is generated based at least in part on the discovered process model.

### BACKGROUND

Processes such as best practice processes are often described at a high and generic level to allow variation and flexibility. When such processes are implemented in an organization, they typically are customized according to the organization's guidelines and rules.

### BRIEF DESCRIPTION OF THE DRAWINGS

FIG. 1 is a diagram of an example system architecture for a process refinement system.

FIG. 2 is a diagram of an example method for the system shown in FIG. 1 to refine a process.

FIG. 3 is a diagram of an example of a computer system.

### DETAILED DESCRIPTION

The present subject matter is now described more fully with reference to the accompanying figures, in which several examples are shown. The present subject matter may be embodied in many different forms and should not be construed as limited to the examples set forth herein. Rather these examples are provided so that this disclosure will be complete and will fully convey principles of the subject matter.

### Example System Architecture

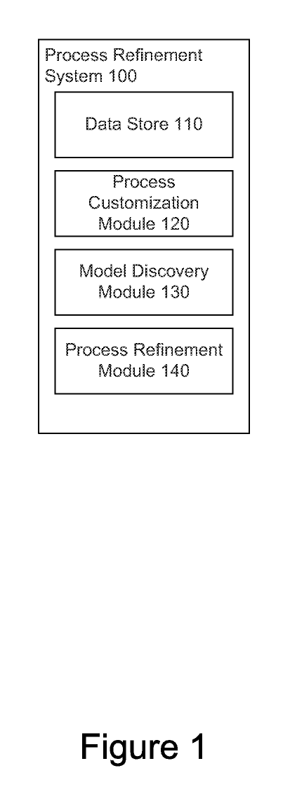

FIG. 1 illustrates one example of a process refinement system 100 that customizes processes and refines the customized processes based on actual execution of the processes. The process refinement system 100 includes a data store 110, a process customization module 120, a model discovery module 130, and a process refinement module 140.

The data store 110 stores data used by the process refinement system 100. Examples of the data stored in the data store 110 include descriptions of processes and enactments of the processes. The data store 110 may be a database stored on a non-transitory computer-readable storage medium.

A process is a sequence of actions (e.g., events, decisions, steps, sub-processes) taken to achieve a result. Example processes include best practice processes from best practice frameworks such as the Information Technology Infrastructure Library (ITIL). Processes can be described in a formal language, as illustrated in the following representation (also called a “process template”) of an example incident management process.

:IncidentManagementProcess a m1:TaskTemplate;

m1:partOf:ITILOperationalManagement;
m1:rType m1:Required;
m1:actorRole m1:HelpDesk, m1:FirstLevelSupport,
m1:SecondLevelSupport;
m1:compositeTasks (

m1:IncidentDetectionAndRecording
m1:Assignment
m1:Classification
m1:InvestigationAndDiagnosis
m1:ResolutionAndRecovery
m1:Closure

).

As shown, the example process includes the following actions: incident detection and recordation, assignment, classification, investigation and diagnosis, resolution and recovery, and closure.

A process may be described at a high and generic level (called an “abstract process template”) to allow variation and flexibility of different organizations. Alternatively, a process may be customized for a specific organization (called a “customized process template”) according to that organization's rules, policies, guidelines, and/or best practices. An abstract process template may be generated based on a description of the underlying process (e.g., by a human operator) and typically contains actions to be done in the process rather than how to act. A customized process template may be generated by the process customization module 120 and typically cony is information about how actions in the process can or should be performed.

An enactment of a process is a unique sequence of actions that has been carried out in the course of the process. A process may have multiple enactments, each of which contains records of instances that realized that enactment. An instance of an enactment (also called a “trace for the enactment” or an “enactment trace”) includes information about the sequence of actions carried out in order to follow the process. In one example, #110 contains temporal information of the enactments as well as the actual actions that are carried out as opposed to the actions in the abstract process template. In one example, a user interface (e.g., web pages on a website available within an organization) is provided for users to access process templates (e.g., customized process templates) and to provide information regarding actions performed to follow the associated processes. The website can generate enactment traces based on the user inputs and store the enactment traces in #110.

The process customization module 120 generates customized process templates tailored specifically for an organization by customizing abstract process templates for that organization. In one example, the process customization module 120 provides a user interface (UI) for a human operator (e.g., a business specialist who is familiar with the organization's rules, policies, guidelines, and/or best practices) to customize the abstract process templates into organization-specific customized process templates. The UI provides operations that the human operator can perform on the abstract process templates, for example, to incorporate organization rules, and best practices. Example operations include removing an action, adding anew action (e.g., an organization-specific best practice action), and customizing an action into one or more specific actions. The customization of an action allows overriding the definition of the action in the abstract process template with a more specific, constrained action in the customized process template. The customization operation also allows the human operator to define constraints on, among others, the role of the person who performs the action, the minimum and/or maximum duration of the action, the policies to be complied while performing the action, and the priority of the action. Thus, a customized process template provides guidance to users who plan to initiate and perform actions in the underlying process. The process customization module 120 may also provide the UI for users to access the customized process templates and to input information regarding actions carried out in order to follow the processes.

The model discovery module 130 generates a discovered process model for a process to capture variations among enactment traces of that process. The model discovery module 130 analyzes the enactment traces of the process to discover how each action in the process is instantiated in the enactments traces. The model discovery module 130 may compute statistics such as the number of times the process has been refined, the number of times that a particular enactment has been realized (e.g., the number of enactment traces for that enactment), and the frequency of each action in the enactment traces. The model discovery module 130 discovers structural deviations from the process templates (abstract process template, customized process template, and/or refined process template) such as variations in the action sequence. The model discovery module 130 may also discover execution level information of the enactments such as the rote(s) of people involved in the enactments, the average duration/delay of the enactments, and the average number of people involved in the enactments. The model discovery module 130 generates the discovered process model to include action sequences of some or all enactments of the underlying process with reference to actions described in the process template. In addition, the discovered process model includes information about how frequently actions are carried out, keywords describing the contexts in which the actions are carried out, information about changes made to the process templates and/or the frequency of such changes.

The process refinement module 140 refines a process template of a process based on the discovered process model of that process. The process refinement module 140 compares the discovered process model with the process template to identify changes made in following the process, and determines the significance of each change based on factors such as the frequency and/or recency of the action involved in the change. The process refinement module 140 then generates suggestions (e.g., to an administrator) for refining the process template to reflect the observed changes. For example, if the frequency and/or recency of a particular change exceed a threshold value, then the process refinement module 140 suggests to perform one or more operations on the process template to reflect this change. Examples of the suggested operations include adding an action, removing an action, updating an action, and changing the action sequence. The updating operation updates detailed description of an action in the process template based on enactment information of the action in the discovered process model. Example enactment information that may be included in the detailed description includes the role of the person who performs the action, the average duration of the action, and the number/portion of enactments that include this action.

For example, if an action in the discovered process model is not included in the process template and the number (or portion) of enactments including the action (or the frequency of the action) exceeds a threshold value, the process refinement module 140 may suggest to add the action to the process template in the order consistent with the action sequences in the enactments. As another example, if an action in the process template has not been used in recent enactment traces, the process refinement module 140 may suggest removing the action from the process template. If the discovered process model suggests that the action sequences in recent enactment traces are different comparing to the action sequence in the process template, the process refinement module 140 may suggest re-ordering the actions or annotating the actions to indicate the other possible orderings and the frequency of such alternative orderings in actual execution of the process.

The process refinement module 140 can be configured to automatically refined process templates without human intervention. The resulting template is called a “refined process template”. The process refinement module 140 can be configured to continuously or periodically refine process templates based on new enactment traces.

### Example Process

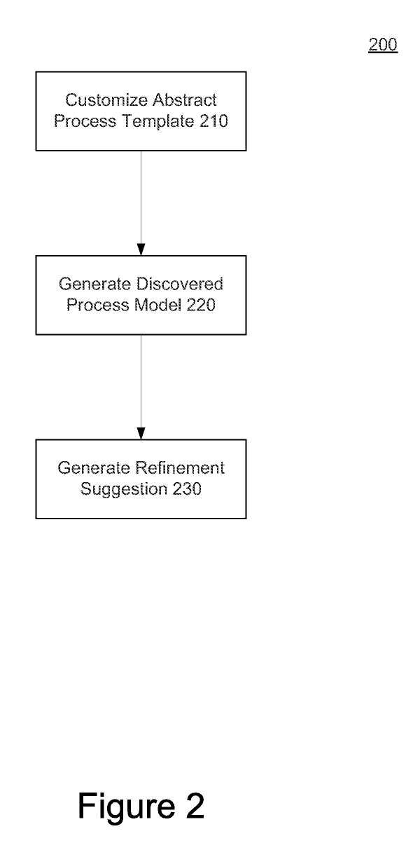

FIG. 2 is a flow diagram that shows an example of a method 200 for the process refinement system 100 to customize a process and refine the process based on actual execution of the process. Other examples perform the steps in different orders and/or perform different or additional steps than the ones shown.

At step 210, the process refinement system 100 customizes an abstract process template into a customized process template. The process refinement system 100 presents a UI that provides information of the abstract process template and enables a user to perform operations to customize the abstract process template (e.g., according to the organization rules, policies, guidelines, and/or best practices) into an organization-specific customized process template. Examples of the operations include removing an action, adding a new action, and customizing an action into one or more specific actions. The process refinement system 100 can then provide a UI for users to access the customized (or abstract) process template and to input information regarding actions actually carried out, and generate enactment traces based on the user input.

At step 220, the process refinement system 100 generates a discovered process model based on enactment traces of the process. The process refinement system 100 analyzes the enactment traces for the process to discover how each action is instantiated in the enactment traces, and computes related statistics. In one example, the process refinement system 100 generates a hierarchical state graph including the action sequences of some or all enactment traces. The state graph includes a path for each action sequence in the enactment traces, and each action in the state graph refers to the corresponding action in the abstract process template. The process refinement system 100 may merge states in the state chart to generate the discovered process model, a compact hierarchical state chart that represents concrete refinements of the corresponding abstract process template with annotations containing information regarding context and actual execution of each action in the process.

At step 230, the process refinement system 100 generates refinement suggestions for a process based on the discovered process model of that process. The process refinement system 100 compares the discovered process model with a process template (e.g., the abstract process template, customized process template, and/or refined process template) of the process to identify changes in the enactment traces that deviates from the process template, and determines the significance of each change based on factors such as the frequency and/or recency of the action involved in the change. The process refinement system 100 generates suggestions for making significant changes to the process template through refinement operations (e.g., updating an action, removing an action, adding an action, and reordering the action sequence). The process refinement system 100 can be configured to periodically or continuously repeat steps 220 and 230 (automatically or through human intervention) to generate suggestions reflecting the latest best practice information regarding how people realize specific enactments, such that the best practice information can be shared with other people.

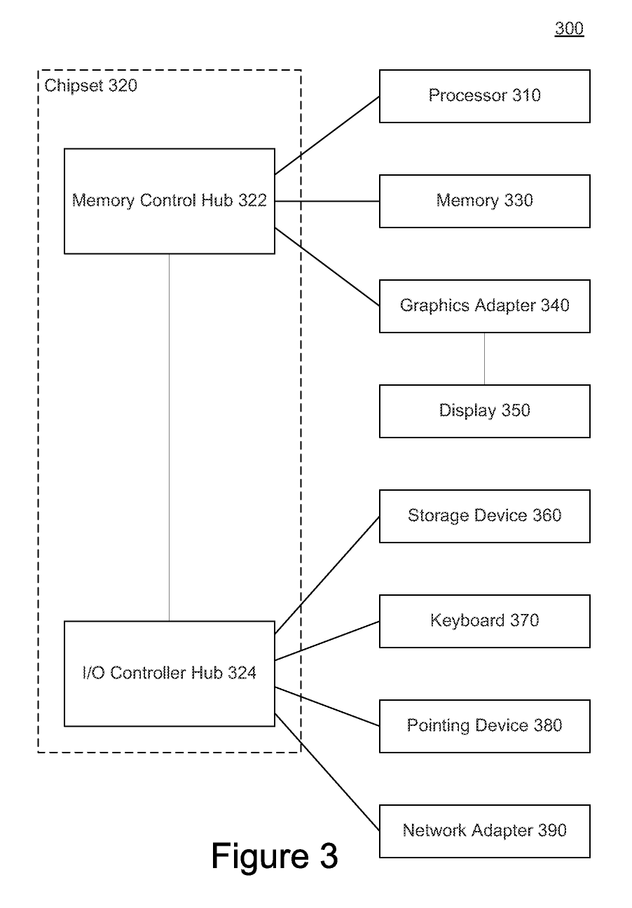

In one example, the entities shown in FIGS. 1 and 2 are implemented using one or more computer systems. FIG. 3 is a high-level block diagram illustrating an example computer system 300. The computer system 300 includes at least one processor 310 coupled to a chipset 320. The chipset 320 includes a memory controller hub 322 and an input/output (I/O) controller hub 324. A memory 330 and a graphics adapter 340 are coupled to the memory controller hub 322, and a display 350 is coupled to the graphics adapter 340. A storage device 360, a keyboard 370, a pointing device 380, and a network adapter 390 are coupled to the I/O controller hub 324. Other examples of the computer system 300 have different architectures.

The storage device 360 is a non-transitory computer-readable storage medium such as a hard drive, compact disk read-only memory (CD-ROM), DVD, or a solid-state memory device. The memory 330 holds instructions and data used by the processor 310. The pointing device 380 is a mouse, track ball, or other type of pointing device, and is used in combination with the keyboard 370 to input data into the computer system 300. The graphics adapter 340 displays images and other information on the display 350. The network adapter 390 couples the computer system 300 to one or more computer networks.

The computer system 300 is adapted to execute computer program modules for providing functionality described herein. As used herein, the term “module” refers to computer program logic used to provide the specified functionality. Thus, a module can be implemented in hardware, firmware, and/or software. In one example, program modules are stored on the storage device 360, loaded into the memory 330, and executed by the processor 310.

The types of computer systems 300 used by entities can vary. For example, the process refinement system 100 might comprise multiple blade servers working together to provide the functionality described herein. A computer system 300 can lack some of the components described above, such as the keyboard 370, the graphics adapter 340, and the display 350. In addition, one or more of the entities may be implemented in a cloud computing environment (e.g., in which dynamically scalable and perhaps virtualized resources are provided as a service over the Internet such that the cloud computing customers may not own the physical infrastructure serving as host to the software platform in question, but instead rent usage of resources from a third-party provider and consume these resources as a service and pay for resources used).

One skilled in the art will recognize that the configurations and methods described above and illustrated in the figures are merely examples, and that the described subject matter may be practiced and implemented using many other configurations and methods. It should also be noted that the language used in the specification has been principally selected for readability and instructional purposes, and may not have been selected to delineate or circumscribe the inventive subject matter. Accordingly, the disclosure of the described subject matter is intended to be illustrative, but not limiting, of the scope of the subject matter, which is set forth in the following claims.

What is claimed is:

1. A computer-implemented method for refining a process, comprising:
generating a customized process template for an organization by customizing an abstract process template of the process for the organization;
generating a discovered process model based on enactment traces of the process; and
generating a suggestion for refining the process based at least in part on the discovered process model.

2. The method of claim 1, wherein the discovered process model is generated based on an enactment trace of the process with reference to at least one action described in the abstract process template, the enactment trace comprising a plurality of actions carried out for the process.

3. The method of claim 2, further comprising:
providing a user interface for enabling a user to access the customized process and to input information related to actions carried out for the process; and
generating the enactment trace based on the input from the user.

4. The method of claim 2, wherein the discovered process model comprises a sequence of the plurality of actions in the enactment trace.

5. The method of claim 1, wherein the discovered process model comprises a frequency of an action carried out for the process and wherein the suggestion is generated based at least in part on the frequency of the action.

6. The method of claim 5, wherein the suggestion comprises a suggestion for including the frequency of the action in the customized process template.

7. The method of claim 1, wherein the suggestion comprises a suggestion for performing at least one of the following operations to the customized process template: adding an action, removing an action, updating an action, and changing an action sequence.

8. A non-transitory computer-readable storage medium having computer program instructions recorded thereon for refining a process, the computer program instructions comprising instructions for:
generating a customized process template for an organization by customizing an abstract process template of the process for the organization;
generating a discovered process model based on enactment traces of the process; and
generating a suggestion for refining the process based at least in part on the discovered process model.

9. The storage medium of claim 8, wherein the discovered process model is generated based on an enactment trace of the process with reference to at least one action described in the abstract process template, the enactment trace comprising a plurality of actions carried out for the process.

10. The storage medium of claim 9, wherein the computer program instructions further comprise instructions for:
providing a user interface for enabling a user to access the customized process and to input information related to actions carried out for the process; and
generating the enactment trace based on the input from the user.

11. The storage medium of claim 9, wherein the discovered process model comprises a sequence of the plurality of actions in the enactment trace.

12. The storage medium of claim 8, wherein the discovered process model comprises a frequency of an action carried out for the process and wherein the suggestion is generated based at least in part on the frequency of the action.

13. The storage medium of claim 12, wherein the suggestion comprises a suggestion for including the frequency of the action in the customized process template.

14. The storage medium of claim 8, wherein the suggestion comprises a suggestion for performing at least one of the following operations to the customized process template: adding an action, removing an action, updating an action, and changing an action sequence.

15. A system for refining a process, comprising:
a process customization module to generate a customized process template for an organization by customizing an abstract process template of the process for the organization;
a model discovery module to generate a discovered process model based on enactment traces of the process;
a process refinement module to generate a suggestion for refining the process based at least in part on the discovered process model; and
a data store to store the customized process template.

16. The system of claim 15, wherein the discovered process model is generated based on an enactment trace of the process with reference to at least one action described in the abstract process template, the enactment trace comprising a plurality of actions carried out for the process.

17. The system of claim 16, wherein the system is configured to provide a user interface for enabling a user to access the customized process and to input information related to actions carried out for the process, and to generate the enactment trace based on the input from the user.

18. The system of claim 16, wherein the discovered process model comprises a sequence of the plurality of actions in the enactment trace.

19. The system of claim 15, wherein the discovered process model comprises a frequency of an action carried out for the process and wherein the suggestion is generated based at least in part on the frequency of the action.

20. The system of claim 19, wherein the suggestion comprises a suggestion for including the frequency of the action in the customized process template.
